(19) United States
(12) Patent Application Publication
(10) Pub. No.: US 2013/0085866 A1
(43) Pub. Date: Apr. 4, 2013

(54) Floating smartphone icon messaging system

(71) Applicants: Ilya Levitis, Aventura, FL (US); Douglas Peters, Boca Raton, FL (US)

(72) Inventors: Ilya Levitis, Aventura, FL (US); Douglas Peters, Boca Raton, FL (US)

(21) Appl. No.: 13/200,878

(22) Filed: Oct. 4, 2011

(51) Int. Cl. G06Q 30/02

(52) U.S. Cl. 705/14.69

(57) ABSTRACT

A floating messaging icon moves in a straight line, curved line or zig zag movement pattern over stationary icons present on the display of a smartphone or tablet having Internet and GPS connectivity. Touching the moving floating messaging icon selects the icon. An Internet connection is thereby established with a sponsoring advertiser, causing coupons and special services to become accessible at the advertiser location. The GPS coordinates of the Smartphone or tablet are used to identify suitable locations of the advertiser within a preselected distance.

### BACKGROUND OF THE INVENTION

1. Field of the Invention

The present invention relates to Internet messaging systems; and, more particularly, to a moving floating messaging icon presented on the display portion of a Smartphone, a tablet or a stationary device having a display screen and Internet connectivity.

2. Description of the Prior Art

There are various devices, such as Smartphones and tablets that display stationary icons. Some of the prior art devices discussed below move an icon towards the cursor when the icon is present close to the curser. In some of the prior art devices discussed below, icons may move on the display screen based on selection of one of the stationary icons displaced on the screen of the device.

U.S. Pat. No. 5,852,440 to Grossman, et al. discloses a method and system for facilitating the selection of icons. Those icons, which are next likely to be used are selected and automatically moved towards a cursor, thereby facilitating selection of the icons. Additionally, those icons likely to be used or other icons selected by a user may track the cursor such that those icons are always close to the cursor and capable of being easily selected. Further, in order to facilitate selection of icons, the latter are provided with the capability of announcing themselves when a cursor comes close to the icon. In addition, it is possible to reduce the amount of clutter on a computer display so that icons may be easily selected. In order to clean up a computer display, icons which are least likely to be used are faded, eliminated or shrunk to a smaller size. Icons that are not used very often may disappear into a master icon and further, icons which have a conceptual relationship between them may be linked by a visual graphical representation. Icons which are close to a cursor and frequently used are made bright and can be easily accessed. Icons which are rarely used, are dimmed. The commonly used, bright icons move closer to the curser for easy access. The icon does not float over other stationary icons and is not a floating advertisement icon.

U.S. Pat. No. 6,904,570 to Foote, et al. discloses a method and apparatus for controlling a display of data on a display screen. This user interface of a smart compact device employs a combination comprising a display screen in combination with an activating object that is capable of reporting X and Y position information in a first state and a second state. Selected data is displayed or hidden, depending on whether the first state or second state is detected. The display screen is configured to report position information of an activating object disposed in the screen of a touching state and a proximate non-touching state. Means are configured to display data on said display screen responsive to the activating object being disposed in said proximate non-touching state for a selected time period. Other means are configured to hide at least a portion of said data responsive to said activating object being disposed in said touching state. The order method presents a data list on the view-screen of a phone and a pen is used to select a line item from the list presented when a pen is drawn over the line, at which point detailed information regarding the line selected is presented. Additional items may be selected from the detail list. Taking the pen outside the data list reverts back to the original list presented. The presentation of a list is not presentation of a floating moving messaging icon. Unlike the floating messaging icon of the subject invention, which upon selection launches the web page of the advertiser or any company that wishes to use the floating messaging icon, the invention disclosed by the '570 patent merely presents another data list corresponding to the selection from the previously presented data list.

U.S. Pat. No. 7,966,576 to Dongelmans discloses a method and system for moving an icon on a graphical user interface. This method provides a graphical user interface that includes displaying a graphic representation of a data object at an initial location, receiving a command selecting the data object from a user, moving the graphical representation of the data object towards a destination location upon receiving an indication of the destination location from a user. This causes an indirect transition of the object from a first state to a second state at a time when the graphical representation of the data object is positioned substantially at a final destination location. Output enables a user to distinguish the first state from the second state. A first timer is started in response to receiving an indication of a destination location from a user through the interface. The transition from the first state to the second state is automatically caused only after the first timer has run over a pre-determined period of time. The method and system for moving an icon on a graphical user interface disclosed by the '576 patent has an icon on a touch screen surface which is initially in the ‘idle’ or non-floating state. When the user touches this icon its state changes to ‘floating’ and can be moved to a different location on the touch screen display. The icon represents a document file; it is not a link that launches the web site of advertising organization. The icon does not float over other stationary icons all by itself in a curved, zigzag, or other regular or irregular paths, but is instead moved by the user.

U.S. Patent Application No. 20100130179 to Colligan, et al. discloses a system and method for providing advertisement data or other content. This method comprises the steps of providing advertisement data to a mobile device, receiving an input associated with the mobile device based on the advertisement data and the step of providing a credit based on the input, wherein the input is based on the location of the mobile device. The messaging communication is initiated using the mobile device when the mobile device is within a pre-determined distance from an establishment that is associated with advertisement data. The advertisement is provided only when the mobile device is present within a predetermined distance from the advertising establishment. The advertisement may be delivered as a link that connects to the web page of the advertising establishment. The mobile device is not indicated to be a touch screen device with GPS. The advertisement is not provided beyond a pre-determined distance from the advertising establishment and is not in the form of a floating advertisement icon that can be activated to access the web page of the advertising establishment or discarded by touching the screen outside the floating advertisement icon.

U.S. Patent Application Nos. 20100273525 and 20110164264 to Silverbrook, et al. disclose linking an object to a position on a surface. A method for generating an association between a software object and a position on a surface is disclosed. The method starts by sensing, using a sensing device placed on surface coded data at the position on the surface. The coded data at the position on the surface encodes an identity of the surface and the position of the coded data relative to the surface. The sensing device then generates indicating data using the sensed coded data. The indicating data is indicative of the identity of the surface and the position of the sensed coded data relative to the surface. Upon receiving the indicating data from the sensing device by a computer system, the computer system identifies, using the indicating data, the identity of the surface and the position of the sensed coded data relative to the surface. The computer system also identifies the software object, and then generates an association between the identity of the surface, the position of the sensed coded data relative to the surface, and the software object. The object is selected by clicking, using a NetPage pointer. The object is not activated by touching a touch screen floating messaging icon.

U.S. Patent Application No. 20110161852 to Vainio, et al (hereinafter, “the '852 patent application”) discloses a method and apparatus for fluid graphical user interface. This method includes causing, at least in part, display of selectable objects on a graphical user interface, where each of the selectable objects corresponds to data or an application accessible via the graphical user interface. The method further includes causing, at least in part, display of the selectable objects in motion travelling across the graphical user interface based on a category of the selectable object or context dependent data, and allowing user selection and manipulation of the selectable objects displayed on the graphical user interface. In this method individual icons are present on a screen display and one of the icons is moved by the user to a ‘first category’ or ‘source’ location. The system examines all icons present on the screen and causes travel movement of all icons that are related to the source. The user may select any of the moving icons to activate its functionality. The moving or floating icons are not floating advertisement icons provided by an advertising enterprise. The movement of icons in the '852 patent application is strictly controlled by their relationship to the selected ‘first category’ or ‘source’ selected by the user; it has nothing to do with a floating moving icon displayed on a screen.

Based on the foregoing, there exists a need for an advertisement means or communication means wherein an advertising icon or messaging icon is floated over other stationary icons displayed on a screen of a Smartphone or a tablet device, wherein the movement of the icon attracts the attention of the user enabling the user to select the icon to receive additional information and benefits such as coupons and special services.

### SUMMARY OF THE INVENTION

The present invention provides a moving floating icon that moves over displayed stationary icons present on the display of a smart phone, a tablet or a stationary device having Internet connectivity, wherein the floating icon is provided by an advertiser of services and sale events. The floating or moving messaging icon is presented on the touch screen of a Smartphone or a tablet that has Internet connectivity and, optionally, GPS location identifying features. The floating messaging icon floats over stationary icons present in a main screen or windows of applications running on the Smartphone or tablet. The user activates the floating messaging icon by touching the icon. This triggers Internet connectivity between the Smartphone or tablet and a web location with which the floating messaging icon is associated. Upon being connected to the web location, the Smartphone or tablet user is presented with opportunities to acquire coupons, special services, products and the like. The user of the Smartphone or tablet may dismiss this floating messaging icon by merely touching a portion of the screen that is outside the floating icon. The floating mesaging icon attracts the attention of the user due to its movement and optionally its blinking characteristics. It encourages the user to take advantage of the features available through the advertisement. The advertisements are presented to the user at random time intervals or time intervals that are spaced apart at pre-selected or random time periods. The user may disable the floating advertisement feature entirely by setting the preferences menu of the floating advertisement icon program or through the controlling website, and may turn this feature on anytime when the user wants to be informed of advertisements and features available. The floating icons may have specific, individualized, icons representative of available products or services. Preferably, the icon floats on top of, and is transparent. The actual picture that the icon will contain is typically provided by the advertiser. For example, if the advertiser were Mcdonalds, the floating icon might contain a picture of the double arches for which Mcdonalds has achieved brand recognition. In such a case, the icon might be a circle or square with the double arches picture. In another case, the outline figure of the icon could contain a Lady Gaga album cover, or the like. Such icons could, for example, be shaped in the form of a burger, musical instrument, gas station, and the like, contained within an outline figure. In such cases it would be preferable if the outline figure contained a form for which the advertiser has achieved brand recognition. When the Smartphone or tablet has GPS capabilities, it may look for businesses of interest within a fixed distance, for example 10 miles from the location of the Smartphone or tablet. This feature is especially well suited for use by a traveler that has a Smartphone or tablet on hand. Advertisements of particular interest may be selected using the preference menu of the floating messaging icon software program or the website that controls the icon. Advertisers contract for use of the floating icon messaging system by subscribing to a website and from that website will control content of the icon that is displayed on the smartphone of the user. Alternatively, there can exist a default setting by which the user can elect not to subscribe to the website of the system on which the floating icon software resides.

The businesses that advertise using the floating messaging icon system might pay a fee for the system operator to initially present the advertisement on the Smartphone or tablet. When a user clicks on the floating icon, the system generates a fee. This fee is paid by the advertiser and/or the company that uses the messaging object. The software program may also be installed on portable or stationary computers that have Internet connection and, optionally, GPS capability. The user of a Smartphone or tablet is not charged for the floating advertisements. The advertiser, or sponsor of the floating messaging icon, is charged when the user clicks on an icon. In addition, the sponsor of the floating messaging icon may, optionally, be charged for occasions when the floating advertisement appears on the Smartphone or tablet screen. Software for implementing the floating messaging icon system can be preloaded on the Smartphone or tablet, or installed after purchase of the Smartphone or tablet for no additional charge.

This invention relates to a Floating Smartphone Messaging Icon System. Particularly, the Smartphone or tablet device carried by a user can comprise: (i) an installed software adapted to generate an Internet received floating messaging icon that overlaps and covers any stationary icon or window present in the main display of the Smartphone or tablet; (ii) actuating means for actuating the floating messaging icon through use of a touch sensitive Smartphone or tablet screen to thereby select the floating advertisement icon; (iii) the act of touching the floating advertisement icon being operative to launch a web page associated with the messaging icon by means of Internet connectivity, thereby introducing the user to a variety of purchase opportunities and rewards, including special coupons, deals, products and services available at the advertising web page location; (iv) the act of touching the Smartphone or tablet screen outside the floating advertisement icon being operative to dismiss the floating advertisement icon; (v) said software for generating the floating messaging icon having a preferences menu to turn off or turn on the floating advertisement icon feature, and select the type of advertisement desired from the website that controls the icon. This is not the website of the advertiser; and (vi) said Smartphone or tablet having optional GPS features that cooperate with said software to enable the selection of product and service offerings within a preselected distance, such as a radius of 10 miles from the Smartphone or tablet, thereby affording the user a measure of control over the distances required to reach the businesses wherein the product and service offerings are available. The ten (10) mile radius is preferably a default setting, which can be lengthened or shortened by the Smartphone user.

Briefly stated, the Floating Smartphone Messaging Icon System generally comprises: (i) a Smartphone or tablet with a touch screen display, Internet connectivity through Wi-Fi and optional GPS locating features; (ii) said GPS features may use direct receipt of three or more satellite data to compute GPS coordinates or use three or more cell phone tower with known GPS coordinates to determine GPS coordinates; (iii) said floating messaging icon moving along a zigzag pattern, curved lines, horizontal or vertical lines floating and covering over stationary icons or other window features on the touch screen display of the Smartphone or tablet; (iv) said floating messaging optionally blinking to attract the attention of the user of the Smartphone or tablet; (v) the user touching the floating messaging icon launching the connection to the advertising establishment using Internet connectivity and displaying coupons, special services information and the like; (vi) touching the display screen outside the floating advertisement icon being operative to remove the floating messaging icon from the touch screen display. In operation of the system, the messaging icon floats on the screen for about 20 seconds. This would only occur when the phone is on. Preferably, the advertisement sponsor is charged even though the user does not click on the ad; however, in another embodiment a charge is not generated unless the user clicks on the ad. A new advertisement will display or appear every few minutes. Delivery of the advertisement is provided through the Internet connectivity of the Smartphone or tablet.

The software for the floating moving messaging icon may be installed in a stationary computer device that has Internet connectivity. The user may select the floating advertisement icon using a mouse. If the stationary computer has GPS connectivity, it provides the closest location of the advertiser that sponsored the floating advertisement icon.

The floating messaging delivery system confers many benefits:

1) A Smartphone or tablet device user is provided with floating messaging icons that may be selected by merely touching a moving or floating icon which, in turn, immediately connects the Smartphone or tablet to an advertising agency that provides coupons, special services and the like;

2) Based on the preferences menu selections of the floating messaging icon or from the controlling Internet site, the advertisements are filtered appropriately so as to deliver advertisements only of interest to the Smartphone or tablet user and advertisement issuing establishments that are within a pre-selected distance. Advertisements can be displayed using GPS functionality, or using display content at the direction of the sponsor, from the Smartphone or tablet, and easily accessed by the user of the Smartphone or tablet when the device is GPS enabled;

3) The advertising establishments are provided with a quick and easy means of advertising products and services with eye catching advertisements in a user's Smartphone or tablet screen in real-time, if desired;

4) The advertising establishments optionally pay a fee for presenting advertisements as well as a fee triggered when a floating advertisement icon is selected; the costs of these fees, if applicable, are minimal compared to advertisements in regular channels such as news papers or TV advertisements, which may never be read or viewed;

5) The user of the Smartphone or tablet receives the floating messaging icon service at no charge and benefits from timely relevant advertisements that inform the user of specials, coupons, news and the like.

### BRIEF DESCRIPTION OF THE DRAWINGS

The invention will be more fully understood and further advantages will become apparent when reference is had to the following detailed description of the preferred embodiments of the invention and the accompanying drawing, in which:

FIG. 1 illustrates a Smartphone with an messaging icon floating over other stationary icons in a Smartphone;

FIG. 2 illustrates examples of outlines of different floating messaging icons;

FIG. 3 illustrates the system chart of the floating messaging icon system; and

FIG. 4 illustrates the operational modes of the floating messaging icon.

### DETAILED DESCRIPTION OF THE INVENTION

This invention relates to a system that displays an advertiser provided transparent floating icon that moves in a straight line, curved line or zig zag patterns, floating over stationary icons present on the display screen of a Smartphone or tablet device; the user selects the moving item by touching the icon or selection with a curser, finger or a Pen Stylus.

The floating or moving messaging icon is presented on the touch screen of a Smartphone or tablet device that has Internet connectivity and GPS location identifying features. The floating messaging icon floats over stationary icons present in a screen or windows of applications running on the Smartphone or tablet. The user activates the floating messaging icon by touching the icon. This triggers Internet connectivity between the Smartphone or tablet and a web location with which the floating messaging icon is associated. Upon being connected to the web location, the Smartphone or tablet user is presented with opportunities to acquire coupons, special services, products and the like. The user of the Smartphone or tablet may dismiss this floating messaging icon by merely touching a portion of the screen that is outside the floating icon The floating messaging icon attracts the attention of the user and encourages him to take advantage of the features available through the advertisement. The advertisements are presented to the user at random time intervals or time intervals that are spaced apart at pre-selected or random time periods. The user may disable the floating messaging feature entirely by setting the preferences menu of the floating messaging icon software program, or through the website on which the floating icon messaging software resides, and may turn this feature on anytime when the user wants to be informed of advertisements and features available. The floating icons may have specific, individualized, icons representative of available products or services. Such icons can have many shapes, and preferably comprise a picture provided at the direction of the sponsor, ie. Beatles Album cover picture, or Mcdonalds picture, and which is contained inside the floating icon outline. The pictures contained by the floating icon are not stored in a floating object, they are pushed to the object from the website whereon the floating icon messaging software resides. All the advertising selections for each advertiser/ business client are stored on the server of the website hosting the floating icon messing program. The GPS enabled Smartphone or tablet may look for businesses of interest within a fixed distance, for example 10 miles from the location of the Smartphone or tablet. This feature is especially well suited for use by a traveler that has a Smartphone on hand. Advertisement of particular interest may be selected using the preference menu of the floating messaging icon software program or controlling website associated with the floating messaging object.

Generally stated, the Smartphone or tablet device carried by a user can comprise: (i) an installed software adapted to generate a floating transparent messaging icon that overlaps and covers any stationary icon or window present in any screen of the Smartphone or tablet; (ii) actuating means for actuating the messaging advertisement icon through use of a touch sensitive Smartphone or tablet screen to thereby select the floating advertisement icon; (iii) the act of touching the floating messaging icon launching a web page associated with the messaging icon by means of Internet connectivity, thereby introducing the user to a variety of purchase opportunities and rewards, including special coupons, deals, products and services available at the advertising web page location; (iv) the act of touching the Smartphone or tablet screen outside the floating messaging icon being operative to dismiss the floating messaging icon; (v) said software for generating the messaging advertisement icon having a preferences menu to turn off or turn on the floating advertisement icon feature, and select the type of advertisement desired through the website hosting the floating messing icon program; and (vi) said GPS enabled Smartphone or tablet cooperating with floating messaging icon software to enable the selection of product and service offerings within a preselected distance, such as a radius of 10 miles from the Smartphone or tablet, thereby affording the user a measure of control over the distances required to reach the businesses wherein the product and service offerings are available.

The businesses that advertise using the transparent floating messaging icon system optionally pay a fee for the system operator to initially present the advertisement on the Smartphone, tablet or a stationary computer with Internet connectivity. The floating messaging icon is delivered through the Internet connection. An additional charge is applied when a customer elects to look at a specific presented advertisement. The user of a Smartphone, tablet or stationary computer is not charged for the floating advertisements. The advertiser, or sponsor of the floating advertisement icon, is charged when the user clicks on or selects an icon. In addition, the sponsor of the floating advertisement icon may, optionally, be charged for specific occasion' such as a football game or the like when the floating advertisement appears on the Smartphone or tablet screen. Software for implementing the floating advertisement icon system can be preloaded on the Smartphone or tablet, or installed after purchase of the Smartphone or tablet for no additional charge.

The Smartphone may comprise any of commonly available Smartphones including but not limited to iPhone, HTC Inspire, Freestyle, HD7S, Surround, LG Quantum, Encore, Phoenix, BlackBerry Bold, Torch, Pearl 3G , Curve, Samsung Solstice, Focus, Captivate, Infuse, MOTOROLA ATRIX, FLIPSIDE and HP Veer 4G. The floating icon messaging system may also be used in stationary computer base systems such as Microsoft Xbox 360, PS2, Sony PlayStation3, Nintendo DSi XL, Nintendo 3DS and Sony PSP Go as long as these devices have Internet connectivity. These devices may optionally have GPS capability.

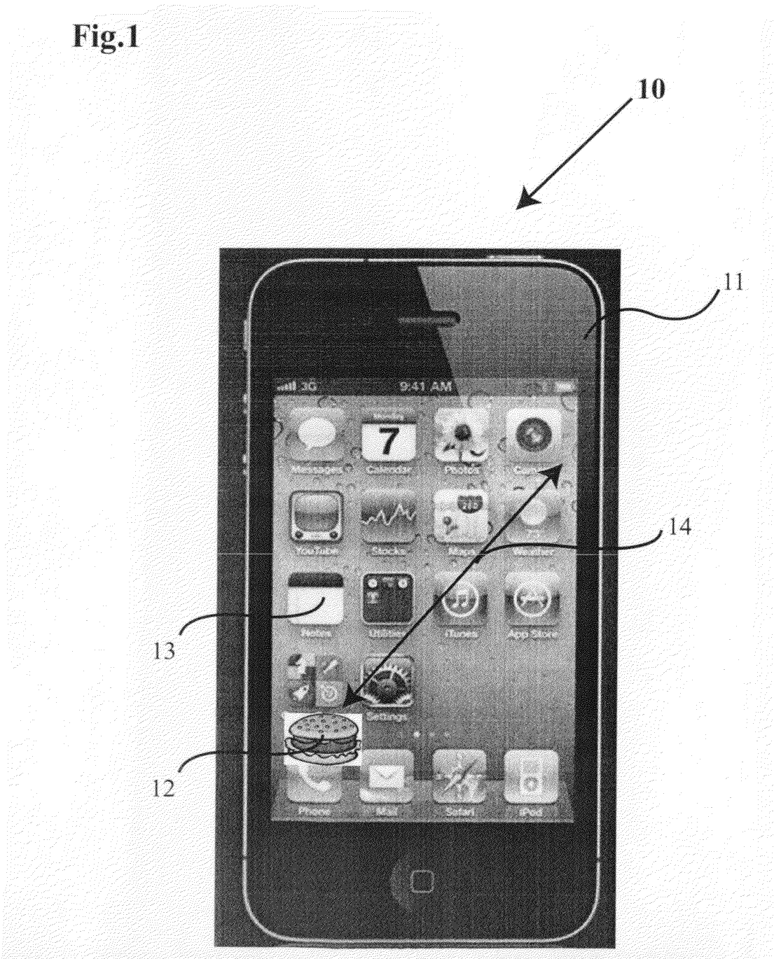

FIG. 1 illustrates at 10 a smartphone 11 with an messaging icon 12 floating over other stationary icons 13 in a Smartphone, such as an Iphone, Android, HTC Smartphone or other Smartphone or PDA of the type sold by Samsung, Apple, Blackberry or the like. The movement of the floating messaging icon on the Smartphone screen is shown at 14 as a linear movement and may follow a zigzagged. linear or curved path. The floating messaging icon may also follow a horizontal or vertical trajectory. It may appear and float briefly and then disappear. The floating messaging icon can blink on and off while moving over other stationary icons in the Smartphone, attracting the attention of the user. During such movement, the transparent icon travels over other stationary icons, covering them. Touching the moving, floating messaging icon selects the advertisement feature. On the other hand, touching the Smartphone touch screen outside the floating messaging icon deselects the floating advertisement icon and dismisses the icon, thereby removing it from the screen display.

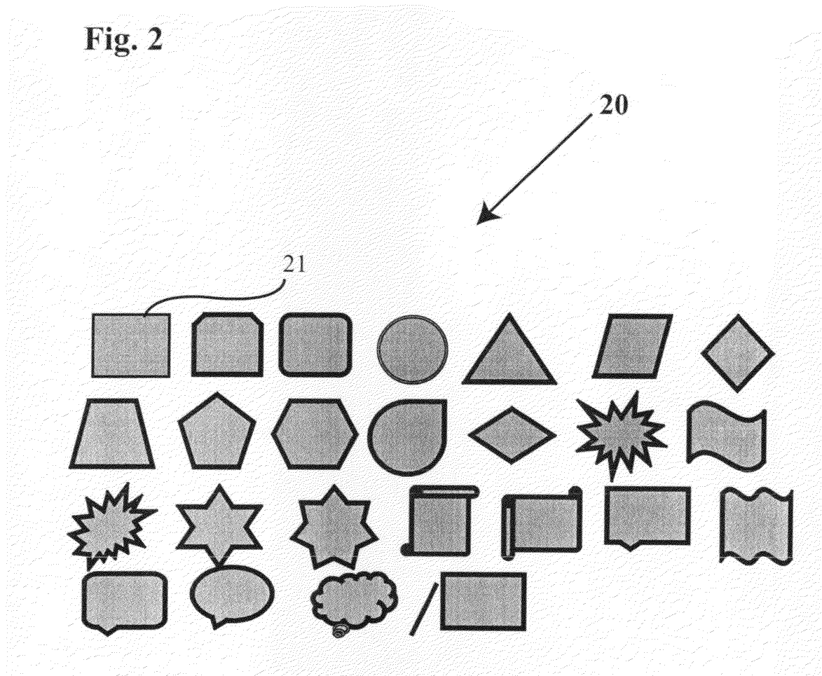

FIG. 2 illustrates at 20 examples of outlines of different floating messaging icons. These examples represent the outline of the icon and the interior of the icon may comprise a figure that represents the service provided. In FIG. 1 the icon has a square shape outline as shown by outline 21 with the included picture of an easy to recognize familiar object such as a burger. Other outline shapes of icons are also shown at 20.

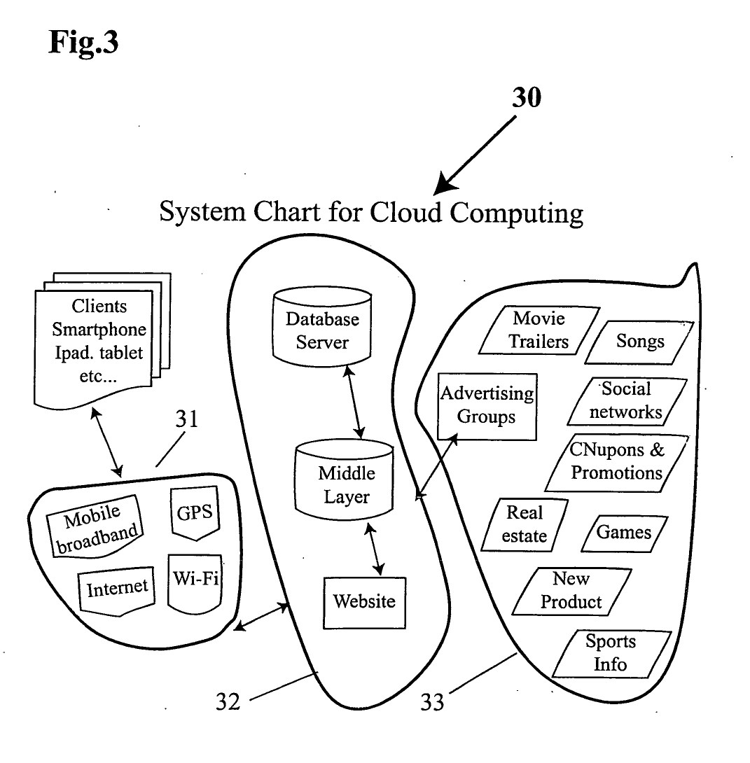

FIG. 3 illustrates at 30 the Cloud system chart of the floating messaging icon system. The customers of the system are the users of Smartphones with 31 Internet connectivity, or Mobile broadband Wi-Fi connection features to access the web and optional GPS capability. Cloud computing 32 server is a physical location, website, database resident on the server, and is accessed by the Smartphones that have the Floating Messaging Icon Software. The middle layer controls an application's functionality by performing detailed processing. The database or business rules can be placed in a middle layer which retrieves data to be sent to Smart phone. 32; this represents the delivery of information to a particular Smartphone of a user having Internet connectivity. Cloud based applications may be used for delivery of content to the Smartphone. The database server 32 has information of a number of advertising groups and may include songs, movie trailers, games, social network, coupon promotion, advertisement for new products, real estate information and sports information. Such information could be stored as a link, so that the database server 2 would store webpage links and pictures appointed for display by the floating messaging icon. Selection of the Floating messaging Icon by the user by touching the floating moving icon on the touch screen of the Smartphone causes the website of the advertising establishment to be displayed which provides information about coupons, special services available and other information detailed above.

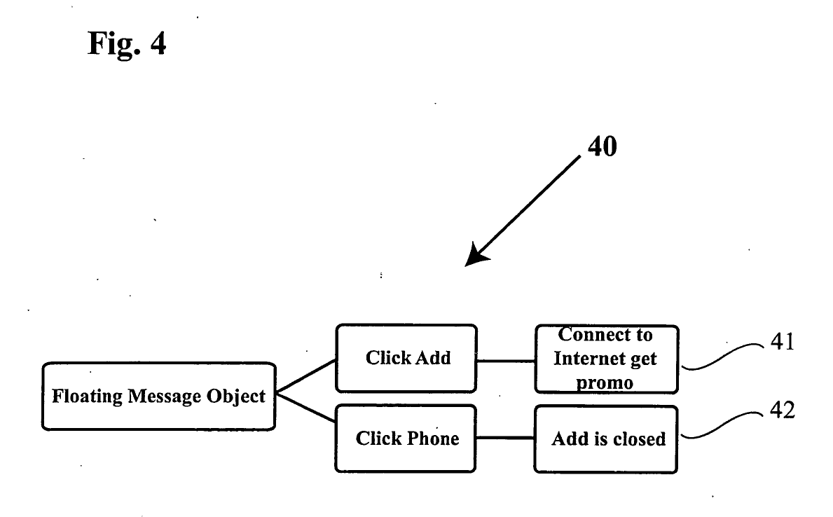

FIG. 4 illustrates at 40 the operational modes of the floating messaging icon. The floating messaging will float over the stationary icons on the display of a Smartphone or tablet until the user makes a choice by touching the floating icon. Clicking on the floating messaging icon allows the user to see the promotion as shown by sequence at 41. Clicking anywhere else on the display screen of the Smartphone or tablet closes the promotional advertisement as shown by sequence at 42.

Significant advantages are realized by practice of the present invention. In its preferred embodiment, the Floating Messaging Icon System of the present invention comprises:
1) A touch screen Smartphone or tablet having Internet connectivity and optional GPS locating features;
2) said Smartphone or tablet comprising software for displaying floating messaging icons that float and move over stationary icons present on the touch screen of the Smartphone or tablet or float above any other application windows;
3) touching the floating messaging icon of the Smartphone or tablet being operative to launch an Internet connection to the web site of the sponsoring advertising establishment, providing specials and coupons that benefit the user;
4) touching the display screen outside the floating moving messaging icon being operative to dismiss the advertisement icon;
5) said software optionally having a preference menu to select a type of advertisement desired and the distance range of advertisement establishments from the Smartphone or tablet that has GPS capability, providing quick easy access for cashing on advertised deals and coupons; and said preference menu optionally residing on the website that hosts the floating icon messaging system program;
6) said advertising establishment optionally paying a fee for delivering the floating advertisement icon to Smartphones and tablets and, as a further option, additionally paying a fee when the user of the Smartphone or tablet selects a floating moving advertisement icon;

whereby the user of Smartphone or tablet is provided with up to date relevant specials and coupons for purchasing goods and services without paying a fee.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A floating messaging icon system comprising:
a) a device having Internet connectivity and a display screen that displays a plurality stationary icons;
b) a floating messaging icon provided through said Internet connectivity by an advertiser after payment for delivery thereof, said icon floating and moving over said stationary icons;
c) selection of the moving floating icon being operative to establish an Internet connection between said device and the advertiser, providing details of promotion available at said advertiser's location;
d) said advertiser being charged for selection of said floating advertisement icon;
e) selection of a portion of said display screen outside the moving floating messaging icon being operative to close the moving floating icon promotion; and
f) a new floating moving messaging icon being delivered to said device after a preselected period of time;
whereby said the user is provided with up to date relevant, specials and coupons for purchase of goods and services without paying a fee.

2. The floating messaging icon system as recited by claim 1, wherein said device is a Smartphone.

3. The floating messaging icon system as recited by claim 1, wherein said device is a tablet.

4. The floating messaging icon system as recited by claim 1, wherein said device is a stationary computer with Internet capability.

5. The floating messaging icon system as recited by claim 1, wherein the floating messaging icon is an image of a familiar object presented within an outline figure.

6. The floating messaging icon system as recited by claim 1, wherein said device has GPS capability and is operative to recommend a nearby advertiser location upon selection of the floating moving advertisement icon.

7. The floating messaging icon system as recited by claim 1, wherein said selection of said floating moving messaging icon is effected by touching a touch sensitive screen.

8. The floating messaging icon system as recited by claim 1, wherein said selection of said floating moving messaging icon is effected by use of a curser.

9. The floating messaging icon system as recited by claim 1, wherein said floating moving messaging icon flashes periodically, to attract attention.

10. The floating messaging icon system as recited by claim 1, wherein movement of said floating messaging icon describes a straight line.

11. The floating messaging icon system as recited by claim 1, wherein movement of said floating messaging icon describes a curved line.

12. The floating messaging icon system as recited by claim 1, wherein movement of said floating messaging icon describes a zigzag movement pattern.
